(19) United States
(12) Patent Application Publication
(10) Pub. No.: US 2026/0230647 A1
(43) Pub. Date: Aug. 6, 2026

(54) METHOD AND APPARATUS FOR VIDEO STREAMING

(71) Applicant: Nokia Technologies Oy, Espoo (FI)

(72) Inventors: Lauri Aleksi ILOLA, Tampere (FI); Lukasz KONDRAD, Munich (DE); Kashyap KAMMACHI SREEDHAR, Tampere (FI); Patrice RONDAO ALFACE, Antwerp (BE); Aleksei MARTEMIANOV, Tampere (FI)

(21) Appl. No.: 19/451,196

(22) Filed: Jan. 16, 2026

Related U.S. Application Data
(60) Provisional application No. 63/746,711, filed on Jan. 17, 2025.

(51) Int. Cl. H04N 19/597; H04N 19/154

(52) U.S. Cl. CPC H04N 19/597; H04N 19/154

(57) ABSTRACT

The embodiments concern a method for encoding and a method for decoding, and the apparatuses for implementing the methods. The method for encoding comprises receiving one or more frames of a volumetric video, the volumetric video comprising a plurality of components, including at least a base mesh component, a displacement component, one or more attribute component, and one or more metadata components; generating one or more segments of each of the plurality of components in one or more quality versions; generating description of each of the plurality of components with information on how a component was encoded and segmented; storing the one or more quality versions of the generated segments on a computer/server; storing the generated description as a description file containing information of each of the plurality of components on a computer/server; sending the description file upon request to a receiver, and sending one or more quality versions of the generated segments upon request of the receiver.

### TECHNICAL FIELD

The present solution relates generally to streaming of volumetric video.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video codec comprises an encoder and a decoder. The encoder transforms an input video into a compressed representation suited for storage and/or transmission. The decoder decompresses the compressed video representation back into a viewable form. During encoding, the encoder may discard some information in the original video sequence to be able to represent the video in a more compact form (that is, at lower bitrate).

Visual Volumetric Video-based coding (V3C) is a standard for video-based point cloud coding (V-PCC) where millions of three-dimensional (3D) data points are converted into a point cloud. This point cloud is finally turned into a 3D image.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus for encoding comprising at least one processor and at least one memory, said at least one memory stored with code thereon, which when executed by said at least one processor, causes the apparatus to: receive one or more frames of a volumetric video, the volumetric video comprising a plurality of components, including at least a base mesh component, a displacement component, one or more attribute component, and one or more metadata components; generate one or more segments of each of the plurality of components in one or more quality versions; generate description of each of the plurality of components with information on how a component was encoded and segmented; store the one or more quality versions of the generated segments on a computer/server; store the generated description as a description file containing information of each of the plurality of components on a computer/server; send the description file upon request to a receiver, and send one or more quality versions of the generated segments upon request of the receiver.

According to a second aspect, there is provided a method for encoding comprising receiving one or more frames of a volumetric video, the volumetric video comprising a plurality of components, including at least a base mesh component, a displacement component, one or more attribute component, and one or more metadata components; generating one or more segments of each of the plurality of components in one or more quality versions; generating description of each of the plurality of components with information on how a component was encoded and segmented; storing the one or more quality versions of the generated segments on a computer/server; storing the generated description as a description file containing information of each of the plurality of components on a computer/server; sending the description file upon request to a receiver, and sending one or more quality versions of the generated segments upon request of the receiver.

According to a third aspect, there is provided an apparatus for encoding comprising means for receiving one or more frames of a volumetric video, the volumetric video comprising a plurality of components, including at least a base mesh component, a displacement component, one or more attribute component, and one or more metadata components; means for generating one or more segments of each of the plurality of components in one or more quality versions; means for generating description of each of the plurality of components with information on how a component was encoded and segmented; means for storing the one or more quality versions of the generated segments on a computer/server; means for storing the generated description as a description file containing information of each of the plurality of components on a computer/server; means for sending the description file upon request to a receiver, and means for sending one or more quality versions of the generated segments upon request of the receiver.

According to a fourth aspect, there is provided computer program product for encoding comprising computer program code configured to, when executed on at least one processor, cause an apparatus or a system to receive one or more frames of a volumetric video, the volumetric video comprising a plurality of components, including at least a base mesh component, a displacement component, one or more attribute component, and one or more metadata components; generate one or more segments of each of the plurality of components in one or more quality versions; generate description of each of the plurality of components with information on how a component was encoded and segmented; store the one or more quality versions of the generated segments on a computer/server; store the generated description as a description file containing information of each of the plurality of components on a computer/server; send the description file upon request to a receiver, and send one or more quality versions of the generated segments upon request of the receiver.

According to an embodiment for any of the previous aspects, the plurality of components are packed in a same packed video component and a description of the packed component is generated.

According to an embodiment for any of the previous aspects and/or embodiment, the description contains one or more of the following: a resolution, a bitrate, a codec, a segment length.

According to an embodiment for any of the previous aspects and/or embodiments, the description comprises information on how geometry component is packed in the packed component.

According to an embodiment for any of the previous aspects and/or embodiments, the metadata component is an atlas.

According to an embodiment for any of the previous aspects and/or embodiments, the description file is a media presentation description.

According to an embodiment for any of the previous aspects and/or embodiments, the description file is generated to contain a descriptor identifying a mesh component.

According to an embodiment for any of the previous aspects and/or embodiments, the mesh component defines one or more of the following: a codec used for encoding; reference to an atlas needed for decoding the base-mesh; type of the base-mesh; number of sub-meshes; identifiers of sub-meshes.

According to an embodiment for any of the previous aspects and/or embodiments, the description file is generated to contain a descriptor identifying an arithmetic coded displacement data component.

According to an embodiment for any of the previous aspects and/or embodiments, the arithmetic coded displacement data component defines one or more of the following: a coding format of arithmetic coded displacement data; identifier for linking the arithmetic coded displacement data component to other components; identifiers for sub-meshes; type of the arithmetic coded displacement data component.

According to an embodiment for any of the previous aspects and/or embodiments, the description file is generated to contain a descriptor identifying a video component supporting packing adaptation.

According to an embodiment for any of the previous aspects and/or embodiments, the video component defines one or more of the following: axis of geometry component along; an order of the geometry component.

According to a fifth aspect, there is provided an apparatus for decoding comprising at least one processor and at least one memory, said at least one memory stored with code thereon, which when executed by said at least one processor, causes the apparatus to: receive a locator identifier of a server that hosts a description file for desired media; request a description file from the server; after having received the description file; parse the description file and determining which adaptation sets are selected initially based on client device hardware capabilities and estimated network conditions; request segments of the needed adaptation sets from the server; receive segments of the requested adaptation sets while keeping track of speed of the reception; and decode segments and displaying volumetric video to a user.

According to a sixth aspect, there is provided a method for decoding comprising receiving a locator identifier of a server that hosts a description file for desired media; requesting a description file from the server; after having received the description file; parsing the description file and determining which adaptation sets are selected initially based on client device hardware capabilities and estimated network conditions; requesting segments of the needed adaptation sets from the server; receiving segments of the requested adaptation sets while keeping track of speed of the reception; and decoding segments and displaying volumetric video to a user.

According to a seventh aspect, there is provided an apparatus comprising at least means for receiving a locator identifier of a server that hosts a description file for desired media; means for requesting a description file from the server; after having received the description file; means for parsing the description file and determining which adaptation sets are selected initially based on client device hardware capabilities and estimated network conditions; means for requesting segments of the needed adaptation sets from the server; means for receiving segments of the requested adaptation sets while keeping track of speed of the reception; and means for decoding segments and means for displaying volumetric video to a user.

According to an eighth aspect, there is provided computer program product for decoding comprising computer program code configured to, when executed on at least one processor, cause an apparatus or a system to receive a locator identifier of a server that hosts a description file for desired media; request a description file from the server; after having received the description file; parse the description file and determining which adaptation sets are selected initially based on client device hardware capabilities and estimated network conditions; request segments of the needed adaptation sets from the server; receive segments of the requested adaptation sets while keeping track of speed of the reception; and decode segments and displaying volumetric video to a user.

According to an embodiment for any of the previous aspects, the locator identifier is a universal resource locator (URL).

According to an embodiment for any of the previous aspects and/or embodiment, it is determined if the network conditions are sufficient to maintain streaming media at current bitrate.

According to an embodiment for any of the previous aspects and/or embodiments, lower quality adaptation of the content is chosen if the bandwidth requirements are not met, and higher quality adaptation of the content is chosen if there is more bandwidth available than needed to stream the current adaptation.

According to an embodiment for any of the previous aspects and/or embodiments, a descriptor identifying a mesh component is determined from the description file.

According to an embodiment for any of the previous aspects and/or embodiments, the mesh component defines one or more of the following: a codec used for encoding; reference to an atlas needed for decoding the base-mesh; type of the base-mesh; number of sub-meshes; identifiers of sub-meshes.

According to an embodiment for any of the previous aspects and/or embodiments, a descriptor identifying an arithmetic coded displacement data component is determined from the description file.

According to an embodiment for any of the previous aspects and/or embodiments, the arithmetic coded displacement data component defines one or more of the following: a coding format of arithmetic coded displacement data; identifier for linking the arithmetic coded displacement data component to other components; identifiers for sub-meshes; type of the arithmetic coded displacement data component.

According to an embodiment for any of the previous aspects and/or embodiments, a descriptor identifying a video component supporting packing adaptation is determined from the description file.

According to an embodiment for any of the previous aspects and/or embodiments, the video component defines one or more of the following: axis of geometry component along; an order of the geometry component.

According to an embodiment for any of the previous aspects and/or embodiments, the computer program product is embodied on a non-transitory computer readable medium.

### BRIEF DESCRIPTION OF THE DRAWINGS

For a more complete understanding of example embodiments of the present invention, reference is now made to the following descriptions taken in connection with the accompanying drawings in which:

FIG. 1 shows an overview of a V-DMC encoder;

FIG. 2 shows an example of a V3C bitstream and possible V3C units it may contain;

FIG. 3 various adaptations of packed video representations;

FIG. 4 is a flow diagram showing a method for encoding according to an embodiment;

FIG. 5 is a flow diagram showing a method for decoding according to an embodiment;

FIG. 6 shows an apparatus according to an embodiment; and

FIG. 7 shows a schematic diagram of an example multimedia communication system within which various embodiments may be implemented.

### DETAILED DESCRIPTION OF THE DRAWINGS

The following description and drawings are illustrative and are not to be construed as unnecessarily limiting. The specific details are provided for a thorough understanding of the disclosure. However, in certain instances, well-known or conventional details are not described in order to avoid obscuring the description. Reference in this specification to “one embodiment” or “an embodiment” means that a particular feature, structure, or characteristic described in connection with the embodiment is included in at least one embodiment of the disclosure.

Before describing the embodiments further, a brief reference to concept of volumetric video is given.

Volumetric video data represents a three-dimensional (3D) scene or object, and can be used as input for AR (Augmented Reality), VR (Virtual Reality), and MR (Mixed Reality) applications. Such data describes geometry (shape, size, position in 3D space) and respective attributes (e.g., color, opacity, reflectance, etc.), and any possible temporal transformations of the geometry and attributes at given time instances (like frames in two-dimensional (2D) video). Volumetric video can be generated from 3D models, also referred to as volumetric visual objects, i.e., CGI (Computer Generated Imagery), or captured from real-world scenes using a variety of capture solutions, e.g., multi-camera, laser scan, combination of video and dedicated depth sensors, and more. Also, a combination of CGI and real-world data is possible. Examples of representation formats for volumetric data comprise triangle meshes, point clouds, or voxels. Temporal information about the scene can be included in the form of individual capture instances, i.e., “frames” in 2D video, or other means, e.g., position of an object as a function of time.

Because volumetric video describes a 3D scene (or object), such data can be viewed from any viewpoint. Therefore, volumetric video is an important format for any AR, VR or MR applications, especially for providing 6DOF (SixDegrees Of Freedom) viewing capabilities.

Increasing computational resources and advances in 3D data acquisition devices have enabled reconstruction of highly detailed volumetric video representations of natural scenes. Infrared, lasers, time-of-flight, and structured light are examples of devices that can be used to construct 3D video data. Representation of the 3D data depends on how the 3D data is used. Dense Voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding, this 3D data as set of texture and depth map as is the case in the multi-view plus depth. Closely related to the techniques used in multi-view plus depth is the use of elevation maps, and multi-level surface maps.

### Volumetric Video

There are many ways to capture and represent a volumetric frame. The format used to capture and represent the volumetric frame depends on the processing to be performed on the frame, and the target application using the frame. Some examples are listed in the following:
A volumetric frame can be represented as a point cloud. A point cloud is a set of unstructured points in 3D space, where each point is characterized by its position in a 3D coordinate system (e.g., Euclidean), and some corresponding attributes (e.g., color information provided as RGBA (Red, Green, Blue, Alpha) value, or normal vectors)
A volumetric frame can be represented as images, with or without depth, captured from multiple viewpoints in 3D space. In other words, it can be represented by one or more view frames (where a view is a projection of a volumetric scene on to a plane (the camera plane) using a real or virtual camera with known/computed extrinsics and intrinsics). Each view may be represented by a number of components (e.g. geometry, color, transparency, and occupancy picture), which may be part of the geometry picture or represented separately.
A volumetric frame can be represented as a mesh. Mesh is a collection of points, called vertices, and connectivity information between vertices, called edges. Vertices along with edges form faces. The combination of vertices, edges and faces can uniquely approximate shapes of objects.
Volumetric frame can be represented as a various N-dimensional primitives, cubes (voxels), spheres, ellipsoids, planes, convex hulls, etc. with various geometric and visual/appearance attributes. Example of one widely used such primitives could be 3D Gaussians.
Volumetric frame can be represented as an implicit neural representations like neural radiance fields (NeRFs).

Depending on the capture, a volumetric frame can provide viewers the ability to navigate a scene with 6DOF, i.e., both translational and rotational movement of their viewing pose (which includes yaw, pitch, and role). The data to be coded for a volumetric frame can also be significant, as a volumetric frame can contain many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC) and ISO/IEC 23008-2 (H.265/HEVC). The metadata can be coded with technologies specified in specification such as ISO/IEC 23090-5. The coded images and the associated metadata can be stored or transmitted to a client that can decode and render the 3D volumetric frame.

### Visual Volumetric Video-Base Coding (V3C)-ISO/IEC 23090-5

ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

Two applications of V3C (ISO/IEC 23090-5) have been defined, V-PCC (ISO/IEC 23090-5) and MPEG Immersive Video (MIV) (ISO/IEC 23090-12). MIV and V-PCC use number of V3C syntax elements with a slightly modified semantics. An example on how the generic syntax element can be differently interpreted by the application is pdu_projection_id.
In case of V-PCC the syntax element, pdu_projection_id specifies the index of the projection plane for the patch. There can be 6 or 18 projection planes in V-PCC, and they are implicit, i.e. pre-determined.
In case of MIV, pdu_projection_id corresponds to a view identifier (ID), i.e., it identifies which view the patch originates from. View IDs and their related information are explicitly provided in MIV view parameters list and may be tailored for each content.

MPEG 3DG (ISO SC29 WG7) group works on a third application of V3C, i.e., the mesh compression. It is envisaged that mesh coding will re-use V3C syntax as much as possible and can also slightly modify the semantics.

To differentiate between applications of V3C bitstream, that allows a client to properly interpret the decoded data, V3C may use the ptl_profile_toolset_idc parameter.

### V3C-V3C Bitstream

V3C bitstream is a sequence of bits that forms the representation of coded volumetric frames and the associated data generating one or more coded V3C sequences (CVS). CVS is a sequence of bits identified and separated by appropriate delimiters, and is required to start with a VPS. CVS includes a V3C unit, and contains one or more V3C units with atlas sub-bitstream or video sub-bitstream. Video sub-bitstreams and atlas sub-bitstreams can be referred to as V3C sub-bitstreams. V3C unit header in conjunction with VPS information identifies which V3C sub-bitstream a V3C unit contains and how it is interpreted

V3C bitstream can be stored according to Annex C of ISO/IEC 23090-5 which specifies syntax and semantics of a sample stream format to be used by applications that deliver some or all of the V3C unit stream as an ordered stream of bytes or bits within which the locations of V3C unit boundaries need to be identifiable from patterns in the data.

### Video-Based Dynamic Mesh Coding (V-DMC)-ISO/IEC 23090-29

V-DMC (ISO/IEC 23090-29) is an application form of V3C that aims on integration of mesh compression into the V3C family of standards. The standard is under development and at DIS stage (MDS24469_WG07_N01027).

The technology is based on multiresolution mesh analysis and coding. This approach consists of:
Generating a base-mesh that is a simplified (low resolution) mesh approximation of the original mesh, called base-mesh (this is done for all frames of the dynamic mesh sequence);
Performing several mesh subdivision iterative steps (e.g., each triangle is converted into four triangles by connecting the triangle edge midpoints on the generated base mesh, generating other approximation meshes);
Defining displacement vectors, also named error vectors, for each vertex of each mesh approximation. Each approximation can be seen as level of details (LoD) of the original mesh.
For each subdivision level by adding the displacement vectors to the subdivided mesh vertices generates the best approximation of the original mesh at that resolution, given the base-mesh and prior subdivision levels.
The displacement vectors may undergo a lazy wavelet transform prior to compression.
The attribute map of the original mesh is transferred to the deformed mesh at the highest resolution (i.e., subdivision level) such that texture coordinates are obtained for the deformed mesh and a new attribute map is generated.

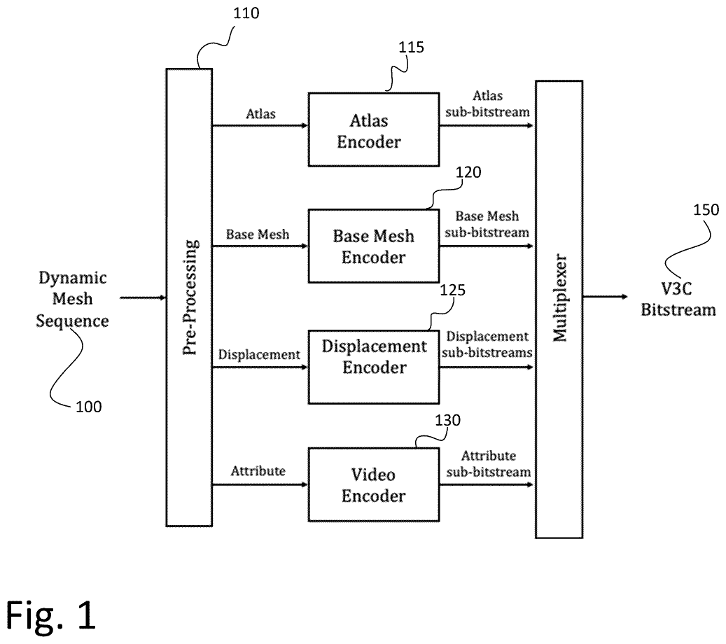

FIG. 1 is an overview of V-DMC encoder. The V-DMC takes dynamic mesh sequence 100 as input and pre-processes 110 the input 100 into multiple representations. These representations include base mesh, a set of displacements, and attributes. The base mesh component represents a simplified version of the detailed mesh describing the object. The displacement component provides displacement vectors which should be applied to the base mesh to obtain the detailed mesh. The attribute components can provide additional properties (e.g., texture or material information). The atlas component provides information to a V3C decoding and rendering system on how to perform inverse reconstruction. Each of the components are encoded in corresponding encoder 115, 120, 125, 130. The V-DMC encoder generates compressed bitstreams which are packet into a V3C bitstream 150 to be provided as an output. The V3C bitstream 150 groups the atlas bitstream and three video components bitstreams, i.e., attribute bitstreams, base mesh bitstream, and displacement bitstream.

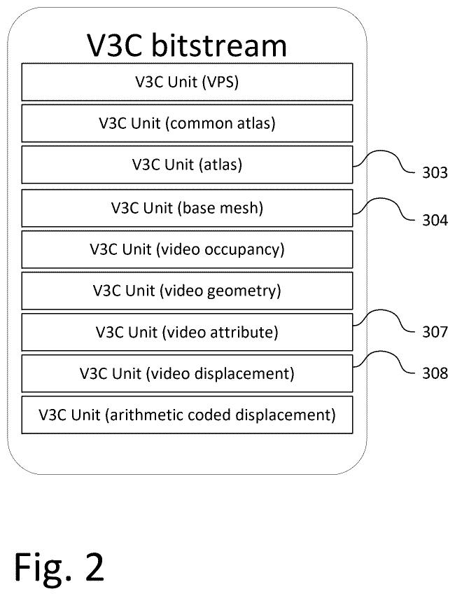

FIG. 2 shows an example of a V3C bitstream with possible units it may contain. Of these units, the following are observed:
A sub-bitstream 304 with the encoded base-mesh using a mesh codec
A sub-bitstream 308 with the displacement vectors:
   packed in an 2D frame and encoded using a video codec or image codec, or
   arithmetic encoded as defined in Annex J of WD ISO/IEC 23090-29,
A sub-bitstream 307 with the attribute map encoded using a video codec
A sub-bitstream (atlas) 303 that contains the metadata required to decode and reconstruct the mesh sequence based on the aforementioned sub-bitstreams 304, 307, 308. The signaling of the metadata is based on the V3C syntax and includes necessary extensions that are specific to meshes.

### Base-Mesh Sub-Bitstream (ISO/IEC 23090-29)

An elementary unit for the output of a base-mesh encoder (Annex H of ISO/IEC 23090-29) is a NAL unit.

A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units can be categorized into Base-mesh Coding Layer (BMCL) NAL units and non-BMCL NAL units. BMCL NAL units can be coded sub-mesh NAL units. A non-BMCL NAL unit may be for example one of the following types: a base-mesh sequence parameter set, a base-mesh frame parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded bas-mesh, whereas many of the other non-BMCL NAL units are not necessary for the reconstruction of decoded sample values.

V-DMC specifications may contain a set of constraints for associating data units (e.g. NAL units) into coded base-mesh access units.

### MPEG EdgeBreaker Static Mesh (ISO/IEC 23090-29: Annex I)

The MPEG EdgeBreaker Static Mesh codec specifies signaling and decoding processes for intra mesh coding based on the well-known EdgeBreaker algorithm, which was extended with several algorithmic enhancements allowing to handle a wider variety of mesh connectivity types and better geometry and UV texture coordinate predictions. It achieves comparable compression performances as the Draco compression.

### Draco Compression

Draco is a technology for compressing and decompressing 3D geometric meshes and point clouds. It is intended to improve the storage and transmission of 3D graphics. Draco supports compressing points, connectivity information, texture coordinates, color information, normals, and any other generic attributes associated with geometry. Draco may compress the 3D mesh either sequentially or using Edgebreaker algorithm. The input to Draco encoder can be any 3D model and the encoder compresses it into a Draco bitstream. The compressed bitstream may be decoded back into the original 3D model, or if needed transcoded into a different format.

### Isobmff-Iso/Iec 14496-12

A basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO base media file format, a file includes media data and metadata that are encapsulated into boxes. Each box is identified by a four character code (4CC) and starts with a header which informs about the type and size of the box.

Many files formatted according to the ISO base media file format start with a file type box, also referred to as FileTypeBox or the ftyp box. The ftyp box contains information of the brands labeling the file. The ftyp box includes one major brand indication and a list of compatible brands. The major brand identifies the most suitable file format specification to be used for parsing the file. The compatible brands indicate which file format specifications and/or conformance points the file conforms to. It is possible that a file is conformant to multiple specifications. All brands indicating compatibility to these specifications should be listed, so that a reader only understanding a subset of the compatible brands can get an indication that the file can be parsed. Compatible brands also give a permission for a file parser of a particular file format specification to process a file containing the same particular file format brand in the ftyp box. A file player may check if the ftyp box of a file comprises brands it supports, and may parse and play the file only if any file format specification supported by the file player is listed among the compatible brands.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they contain an elementary media stream. Other track types comprise hint tracks and timed metadata tracks.

Tracks comprise samples, such as audio or video frames, or metadata frames. For video tracks, a media sample may correspond to a coded picture or an access unit. A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples.

The ‘trak’ box includes in its hierarchy of boxes the SampleTableBox (also known as the sample table or the sample table box). The SampleTableBox contains the SampleDescriptionBox, which gives detailed information about the coding type used, and any initialization information needed for that coding. The SampleDescriptionBox contains an entry-count and as many sample entries as the entry-count indicates. The format of sample entries is track-type specific but derive from generic classes (e.g. VisualSampleEntry, AudioSampleEntry, Volumetric VisualSampleEntry). The type of sample entry form used for derivation the track-type specific sample entry format is determined by the media handler of the track.

A TrackTypeBox may be contained in a TrackBox. The payload of TrackTypeBox has the same syntax as the payload of FileTypeBox. The content of an instance of TrackTypeBox shall be such that it would apply as the content of FileTypeBox, if all other tracks of the file were removed and only the track containing this box remained in the file.

Movie fragments may be used, for example, when recording content to ISO files, for example, in order to avoid losing data if a recording application crashes, runs out of memory space, or some other incident occurs. Without movie fragments, data loss may occur because the file format may require that all metadata, for example, a movie box, be written in one contiguous area of the file. Furthermore, when recording a file, there may not be sufficient amount of memory space to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, e.g., simultaneous reception and playback of a file when movie fragments are used and the initial movie box is smaller compared to a file with the same media content but structured without movie fragments.

The movie fragment feature may enable splitting the metadata that otherwise might reside in the movie box into multiple pieces. Each piece may correspond to a certain period of time of a track. In other words, the movie fragment feature may enable interleaving file metadata and media data. Consequently, the size of the movie box may be limited and the use cases mentioned above be realized.

In some examples, the media samples for the movie fragments may reside in an mdat box. For the metadata of the movie fragments, however, a moof box may be provided. The moof box may include the information for a certain duration of playback time that would previously have been in the moov box. The moov box may still represent a valid movie on its own, but in addition, it may include an mvex box indicating that movie fragments will follow in the same file. The movie fragments may extend the presentation that is associated to the moov box in time.

Within the movie fragment there may be a set of track fragments, including anywhere from zero to a plurality per track. The track fragments may in turn include anywhere from zero to a plurality of track runs, each of which document is a contiguous run of samples for that track (and hence are similar to chunks). Within these structures, many fields are optional and can be defaulted. The metadata that may be included in the moof box may be limited to a subset of the metadata that may be included in a moov box and may be coded differently in some cases. Details regarding the boxes that can be included in a moof box may be found from the ISOBMFF specification.

A self-contained movie fragment may be defined to consist of a moof box and an mdat box that are consecutive in the file order and where the mdat box contains the samples of the movie fragment (for which the moof box provides the metadata) and does not contain samples of any other movie fragment (i.e. any other moof box). A media segment may comprise one or more self-contained movie fragments. A media segment may be used for delivery, such as streaming, e.g. in MPEG-Dynamic Adaptive Streaming over Hypertext Transfer Protocol (HTTP) (MPEG-DASH).

The track reference mechanism can be used to associate tracks with each other. The TrackReferenceBox includes box(es), each of which provides a reference from the containing track to a set of other tracks. These references are labelled through the box type (i.e., the four-character code of the box) of the contained box(es). The ISO Base Media File Format contains three mechanisms for timed metadata that can be associated with particular samples: sample groups, timed metadata tracks, and sample auxiliary information. Derived specification may provide similar functionality with one or more of these three mechanisms.

TrackGroupBox, which is contained in TrackBox, enables indication of groups of tracks where each group shares a particular characteristic or the tracks within a group have a particular relationship. The box contains zero or more boxes, and the particular characteristic or the relationship is indicated by the box type of the contained boxes. The contained boxes include an identifier, which can be used to conclude the tracks belonging to the same track group. The tracks that contain the same type of a contained box within the TrackGroupBox and have the same identifier value within these contained boxes belong to the same track group. The syntax of the contained boxes may be defined through TrackGroupTypeBox is follows:

```
aligned(8) class TrackGroupTypeBox(unsigned int(32) track_group_type)
extends FullBox(track_group_type, version = 0, flags = 0)
{
  unsigned int(32) track_group_id;
  // the remaining data may be specified
  //for a particular track_group_type
}
```

The ISO Base Media File Format contains three mechanisms for timed metadata that can be associated with particular samples: sample groups, timed metadata tracks, and sample auxiliary information. Derived specification may provide similar functionality with one or more of these three mechanisms.

A sample grouping in the ISO base media file format and its derivatives, such as the AVC file format and the scalable video coding (SVC) file format, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroupBox (sbgp box) represents the assignment of samples to sample groups; and (2) a SampleGroupDescriptionBox (sgpd box) contains a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that can be used e.g. to indicate a sub-type of the grouping.

Per-sample sample auxiliary information may be stored anywhere in the same file as the sample data itself; for self-contained media files, this is typically in a MediaDataBox or a box from a derived specification. It is stored either (a) in multiple chunks, with the number of samples per chunk, as well as the number of chunks, matching the chunking of the primary sample data or (b) in a single chunk for all the samples in a movie sample table (or a movie fragment). The Sample Auxiliary Information for all samples contained within a single chunk (or track run) is stored contiguously (similarly to sample data).

Sample Auxiliary Information, when present, is stored in the same file as the samples to which it relates as they share the same data reference (′dref) structure. However, this data may be located anywhere within this file, using auxiliary information offsets (‘saio’) to indicate the location of the data.

The restricted video (‘resv’) sample entry and mechanism has been specified for the ISOBMFF in order to handle situations where the file author requires certain actions on the player or renderer after decoding of a visual track. Players not recognizing or not capable of processing the required actions are stopped from decoding or rendering the restricted video tracks. The ‘resv’ sample entry mechanism applies to any type of video codec. A RestrictedSchemeInfoBox is present in the sample entry of ‘resv’ tracks and comprises an OriginalFormatBox, SchemeTypeBox, and SchemeInformationBox. The original sample entry type that would have been unless the ‘resv’ sample entry type were used is contained in the OriginalFormatBox. The SchemeTypeBox provides an indication which type of processing is required in the player to process the video. The SchemeInformationBox comprises further information of the required processing. The scheme type may impose requirements on the contents of the SchemeInformationBox. For example, the stereo video scheme indicated in the SchemeTypeBox indicates that when decoded frames either contain a representation of two spatially packed constituent frames that form a stereo pair (frame packing) or only one view of a stereo pair (left and right views in different tracks). StereoVideoBox may be contained in SchemeInformationBox to provide further information e.g. on which type of frame packing arrangement has been used (e.g. side-by-side or top-bottom).

Several types of stream access points (SAPs) have been specified, including the following. SAP Type 1 corresponds to what is known in some coding schemes as a “Closed group of pictures (GOP) random access point” (in which all pictures, in decoding order, can be correctly decoded, resulting in a continuous time sequence of correctly decoded pictures with no gaps) and in addition the first picture in decoding order is also the first picture in presentation order. SAP Type 2 corresponds to what is known in some coding schemes as a “Closed GOP random access point” (in which all pictures, in decoding order, can be correctly decoded, resulting in a continuous time sequence of correctly decoded pictures with no gaps), for which the first picture in decoding order may not be the first picture in presentation order. SAP Type 3 corresponds to what is known in some coding schemes as an “Open GOP random access point”, in which there may be some pictures in decoding order that cannot be correctly decoded and have presentation times less than intra-coded picture associated with the SAP.

A stream access point (SAP) sample group as specified in ISOBMFF identifies samples as being of the indicated SAP type.

A sync sample may be defined as a sample corresponding to SAP type 1 or 2. A sync sample can be regarded as a media sample that starts a new independent sequence of samples; if decoding starts at the sync sample, it and succeeding samples in decoding order can all be correctly decoded, and the resulting set of decoded samples forms the correct presentation of the media starting at the decoded sample that has the earliest composition time. Sync samples can be indicated with the SyncSampleBox (for those samples whose metadata is present in a TrackBox) or within sample flags indicated or inferred for track fragment runs.

### MPEG Dynamic Adaptive Streaming Over HTTP (DASH)

DASH is a streaming technology used for delivering video, audio or other timed data over the internet. It allows dynamically adjusting the quality of a media stream based on the user's available network conditions and device capabilities. It is a widely used tool for streaming video online. The DASH is based on HTTP, which is known for its capability to penetrate firewalls and reliable delivery. Segment based delivery also works well for caching on various network nodes and content delivery networks.

DASH uses a Media Presentation Description (MPD) to describe what media is available on the server and in what quality. DASH client can use a manifest file to select various versions of the media based on its network conditions or device capabilities. DASH ingests small segments of the media to allow switching between different representations and to split the media into streamable chunks of data.

### Media Presentation Description (MPD)

The DASH manifest file, also known as the Media Presentation Description (MPD), is written in Extensible Markup Language (XML) and provides description for the streamed media content. It describes the content, available quality options, and the location of individual segments.

The MPD file starts with the MPD element, which is the root element. It contains attributes such as type, which specifies whether the content is static (on-demand) or live, minBufferTime, which defines the minimum amount of content to buffer, and mediaPresentationDuration, which specifies the total duration of the media presentation.

The MPD contains one or more Period elements, each representing a specific time period within the media presentation. Different periods might correspond to ad breaks or distinct sections of the content. Each period contains one or more AdaptationSet elements.

An AdaptationSet groups media streams that represent the same content but in different formats or qualities. For instance, it might include different video resolutions, audio languages, subtitle tracks or metadata tracks. This element typically specifies attributes like mimeType (e.g., video or audio), codecs (the encoding format), and lang (the language of the content, for audio or subtitles).

Within an AdaptationSet, there are one or more Representation elements, which describe individual versions of the content. Each Representation corresponds to a specific combination of bitrate, resolution, or codec. Common attributes in a Representation include id, which uniquely identifies it, bandwidth, which indicates the bitrate, and dimensions like width and height for video.

The manifest also includes segment information, which defines how the media content is split into segments for playback.

In the current version of V-DMC, key enablers for supporting DASH-based streaming of V-DMC encoded data are missing. There is no support for arithmetically coded displacement sub-bitstream or the base-mesh sub-bitstream. Furthermore, adaptation of packed video sub-bitstream, when video coded displacement data is present in the geometry component requires further clarification. In addition, no signaling for such is provided.

Therefore, aspects that relate to segmented delivery of V-DMC encoded content remain unexplored particularly when it comes to different types of bitrate adaptation techniques and their signaling. As an example, V-DMC allows encoding displacement values either as video encoded bitstream or arithmetically encoded bitstream. When displacement values are stored in video frames, the pixel values of the video frames indicate how much the corresponding vertices need to be displaced during the reconstruction. This means that it should not be possible to scale displacement maps: increasing the resolution brings no gains and decreasing the resolution will result in degradation of quality for the reconstructed mesh, as the same displacement values would then be mapped to multiple vertices. This brings special considerations especially when video-coded displacement data is streamed using the packed video technology, which combines multiple video-coded attributes into the same video frame.

The present embodiments provide a signaling mechanism to enable streaming of V-DMC encoded content-including all the V-DMC sub-bitstreams-over DASH. In particular, the present embodiments provide a design which allows signaling of the necessary information between a server (or an encoder) and a client (or a decoder). The embodiments consider the following viewpoints:
establishing signaling for arithmetically coded displacement data,
establishing signaling for coded base-mesh information, and
defining process and optional signaling for adaptation of packed video with video-coded displacements.

In order to achieve this, the encoder (or a sender or a server) according to an embodiment may perform the following:
receiving one or more frames of a volumetric video, the volumetric video comprising a plurality of components, including at least a base mesh component, a displacement component, one or more attribute component, and one or more metadata components;
optionally packing the components in the same packed video component and generating a description of the packed component;
generating one or more segments of each of the plurality of components in one or more quality versions. If the content is uncompressed, encoding each segment using one or more codecs.
generating description of each of the plurality of components with information on how a component was encoded and segmented. The description may contain a resolution, a bitrate, a codec, a segment length, or other quality altering parameter. For a packed component, the encoder indicates how (packing axis and order) geometry component was packed in the packed component.
storing the one or more quality versions of the generated segments on a computer/server.
storing the generated description as a description file containing information of each of the plurality of components on a computer/server.
sending the description file upon request to a receiver.
sending one or more quality versions of the generated segments upon request of the receiver.

Aforementioned metadata component can be atlas data as defined in ISO/IEC 23090-5 and ISO/IEC 23090-29. Aforementioned description file can be a media presentation description (MPD).

The decoder (or a receiver or a client) according to an embodiment may perform the following:
receiving a locator identifier (e.g., URL) of a server that hosts a description file for desired media.
requesting a description file from the server.
after having received the description file, parsing the description file and determining which adaptation sets are selected initially based on client device hardware capabilities (codec, resolution, etc.) and estimated network conditions (congestion, bandwidth, latency, etc.).
requesting segments of the needed adaptation sets from the server.
receiving segments of the requested adaptation sets while keeping track of speed of the reception to determine if network conditions are sufficient to maintain the streaming media at current bitrate. If the bandwidth or latency requirements are not met, lower quality adaptation of the content is chosen. If there is more bandwidth available than needed to stream current adaptation, higher quality adaptation of the content is chosen.
decoding segments and displaying volumetric video to a user. In case of a packed video with embedded video coded displacement information, the decoder rewrites packing information values in decoded atlas data based on the description file.

The embodiments as described above are discussed in more detailed manner in the following.

In a general sense, a streaming expects a description of the streamable content so that a client or a receiver can understand what a server can stream and what content adaptation is available to it in terms of bitrates, alternative video codecs, etc. For DASH delivered content, this description is called Media Presentation Description (MPD). Currently, it is not possible to stream V-DMC encoded content because the description file does not contain the necessary information to indicate how the receiver should select content and its alternatives from the server. Hence, new information is needed in the description. Notably, the description is missing support for streaming base-mesh information, arithmetic encoded displacement data and details on video coded displacement data adaptation with packed video.

### Base-Mesh Component

In order to stream V-DMC encoded mesh information, a new indicator is needed for the description file that indicates that an adaptation set contains a base-mesh component. The base-mesh component adaptation set needs additional information to describe how it can be used for adaptation. The information may include the following attributes:
a codec that was used to encode the base-mesh track;
a reference to the atlas track that is needed to properly decode the base-mesh track;
a type of the base-mesh track, whether it contains a subset of the entire base-mesh or all submeshes;
the number of submeshes in the adaptation set and their ids.

Some of these attributes may be inherited from the Adaptation Set main class, such as the codecs and id attribute, in which case new values can be defined for the existing attributes. The codecs attribute of the Mesh Component Adaptation Set will indicate the coding format of the mesh bitstream. This can be any mesh codec such as Draco or MPEG Edgebreaker. The id-attribute is a unique identifier of the adaptation set that allows other elements in the description to refer to the base mesh adaptation set.

Other extensions need a new descriptor. To identify the Mesh Component Adaptation Set, a new MeshComponent descriptor is introduced. A MeshComponent descriptor is an EssentialProperty descriptor with the @schemeIdUri set to a specified string that matches the registered name of the standard, e.g. “urn:mpeg:mpegI:v3c:2025:meshComponent”. At Adaptation Set level, one or more MeshComponent descriptors shall be signaled for each mesh component that is present in the Representations of the Mesh Component Adaptation Set. The @value of the MeshComponent descriptor does not need to be present. The MeshComponent descriptor may include elements and attributes as specified in a table 1 below:

TABLE 1

| Elements and attributes | Use | Data type | Description |
|---|---|---|---|
| meshComponent | 0 . . . N | v3c: | An element whose attributes |
| | | MeshComponentType | specify information for the V3C |
| | | | mesh components present in the |
| | | | Representation(s) of the |
| | | | Adaptation Set. |
| meshComponent@sub_mesh_ids | O | xs: | Specifies submeshes related to |
| | | UIntVectorType | data contained in the Adaptation |
| | | | Set by providing a white-space |
| | | | separated list of submesh ID |
| | | | values. |
| | | | If not present, the Adaptation Set |
| | | | will contain all submeshes of |
| | | | associated with the |
| | | | representation. |
| meshComponent@type | O | xs: string | Indicates if the base-mesh |
| | | | contains all submeshes of the |
| | | | representation. |
| meshComponent@num_submeshes | O | xs: UInt | Indicates the number o |
| | | | submeshes in the adaptation set. |

Key:
For attributes: M = Mandatory, O = Optional, OD = Optional with Default Value, CM = Conditionally Mandatory.
For elements: <minOccurs> . . . <maxOccurs> (N = unbounded)
Elements are bold; attributes are non-bold and preceded with an @.

It is to be noticed that the examples in the table should not be considered a full set. Some or all of them may be present. Some are mutually exclusive, and the values of some attributes may be derived from the values of other attributes. For example, @sub_mesh_ids may carry additional semantics that indicate the type of the base-mesh component and the number of submeshes it contains.

### Arithmetic Coded Displacement Data (ADD) Component

To indicate the presence of ADD Component as an Adaptation Set, a new ADDComponent descriptor is introduced. The ADDComponent descriptor is an EssentialProperty descriptor with the @schemeIdUri set to a string indicating the registered version of the standard, e.g. “urn:mpeg:mpegI:v3c:2025:ADDComponent”. At Adaptation Set level, one or more ADDComponent descriptor shall be signaled for each ADD Component that is present in the Representations of the ADD Component Adaptation Set. The @value of the ADDComponent descriptor does not need to be present. The ADDComponent descriptor may include elements and attributes as specified in a table 2 below.

The @codecs attribute of the ADD Component Adaptation Set will indicate the coding format of the ADD bitstream. This can be any ADD codec such as the inverse binarization process as defined in 23090-29 Annex K. Similarly, the @id attribute of the ADD Component Adaptation Set can be used to link it to other V-DMC components consisting of the same presentation.

TABLE 2

| Elements and attributes | Use | Data type | Description |
|---|---|---|---|
| ADDComponent | 0 . . . N | v3c: | An element whose attributes |
| | | ADDComponentType | specify information for the V3C |
| | | | AE components present in the |
| | | | Representation(s) of the |
| | | | Adaptation Set. |
| ADDCompo- | O | xs: | If present, indicates the |
| nent@sub_{—}mesh_{—}ids | | UIntVectorType | submesh IDs carried in the |
| | | | Adaptation Set. |
| | | | The value of the |
| | | | @sub_mesh_ids attribute is a |
| | | | whitespace separated list of |
| | | | submesh IDs. |

Key:
For attributes: M = Mandatory, O = Optional, OD = Optional with Default Value, CM = Conditionally Mandatory.
For elements: <minOccurs> . . . <maxOccurs> (N = unbounded)
Elements are bold; attributes are non-bold and preceded with an @.

### Adaptation of Packed Video Representations

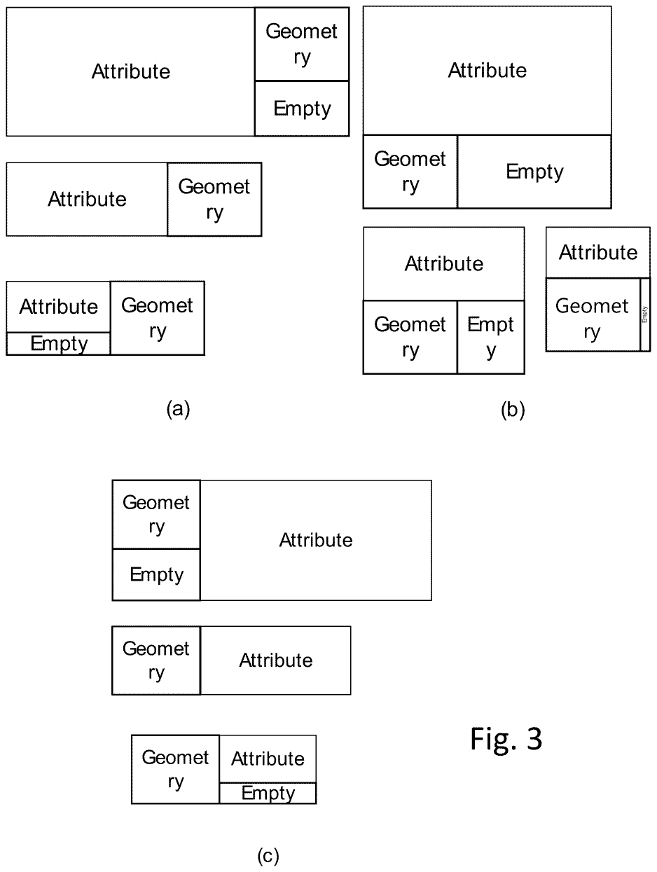

In order to handle adaptation of packed video representations effectively, where the embedded geometry video component contains displacement information, special processing of information should be considered. Scaling video coded displacement component up or down is not considered beneficial, so the resolution of the video coded displacement component should remain static regardless of the texture or packed video resolution that is used. FIG. 3 illustrates examples a)-c) on how adaptation of packed video component can behave, when the packed video component also contains the attribute component. Globally scaling the resolution of the packed video frame up and down should not be done as it can result in severe reconstruction artefacts due to the nature of the displacement data. Alternative packing schemes may be considered, but the geometry resolution inside the packed frame should not change. In the examples of FIG. 3, the geometry video component resolution remains fixed while attribute component resolution is scaled. FIG. 3a shows an adaptation of packing on x-axis with geometry ordered last. FIG. 3b shows an adaptation on y-axis with geometry ordered last. FIG. 3c shows adaptation of packing on x-axis with geometry ordered first.

With regard to signaling, there are two alternatives. On one hand, the signaling can be handled as part of the atlas data which describes the location where each component is stored in the packed frame. This is described in more detailed manner in Table 3 below. This means that also encoded alternatives of the atlas data need to be provided along with each adaptation of the packed video adaptation set, which can be costly.

TABLE 3

| | Descriptor |
|---|---|
| packing_information( j ) { | |
| ... | u(8) |
| for( i = 0; i <= pin_regions_count_minus1[ j ]; i++ ) { | |
| ... | u(8) |
| pin_region_top_left_x[ j ][ i ] | u(16) |
| pin_region_top_left_y[ j ][ i ] | u(16) |
| pin_region_width_minus1[ j ][ i ] | u(16) |
| pin_region_height_minus1[ j ][ i ] | u(16) |
| ... | u(16) |
| } | |
| } | |

On the other hand, to provide more data efficient design, it is beneficial to enforce specific behavior of the decoder where the decoder rewrites the necessary data fields in the atlas data based on the resolution of the packed video component adaptation set. This is possible, when both the encoder and the decoder know and share an understanding how the packing is changed when the overall resolution of the packed video component is changed. For example, the decoder can always rely on the fact that the resolution of the geometry component is fixed and it will not be changed, when the packed video resolution is changed. When the geometry component is appended on the x-axis after the attribute component, it can derive the attribute component resolution assuming that the aspect ratio of the attribute component will not change.

To make the latter design more configurable, the axis of geometry component packing in the video frame may be signaled along with the order of packed components. This would require adding two new attributes in the video component descriptor as given in the example of Table 4 below.

TABLE 4

| Elements and attributes | Use | Data type | Description |
|---|---|---|---|
| videoComponent | 0 . . . N | v3c: VideoComponentType | An element whose attributes |
| | | | specify information for one of |
| | | | the V3C video components |
| | | | present in the Representation(s) |
| | | | of the Adaptation Set. |
| videoComponent@geometry- | O | xs:boolean | A flag indicating whether the |
| packing-axis-x | | | V3C video component contains |
| | | | packed geometry on X-axis. |
| | | | When the value is set to false, |
| | | | the geometry is packed on the |
| | | | Y-axis. |
| | | | The attribute may only be |
| | | | present when the V3C video |
| | | | component contains packed |
| | | | video component. |
| videoComponent@geometry- | O | Xs: Uint | Indicates the order of the |
| packing-order | | | geometry component in the |
| | | | packed video frame. The value |
| | | | 0 indicates that the geometry |
| | | | component is packed first in the |
| | | | video frame. |
| | | | The attribute may only be |
| | | | present when the V3C video |
| | | | component contains packed |
| | | | video component. |

Key:
For attributes: M = Mandatory, O = Optional, OD = Optional with Default Value, CM = Conditionally Mandatory.
For elements: <minOccurs> . . . <maxOccurs> (N = unbounded)
Elements are bold; attributes are non-bold and preceded with an @.

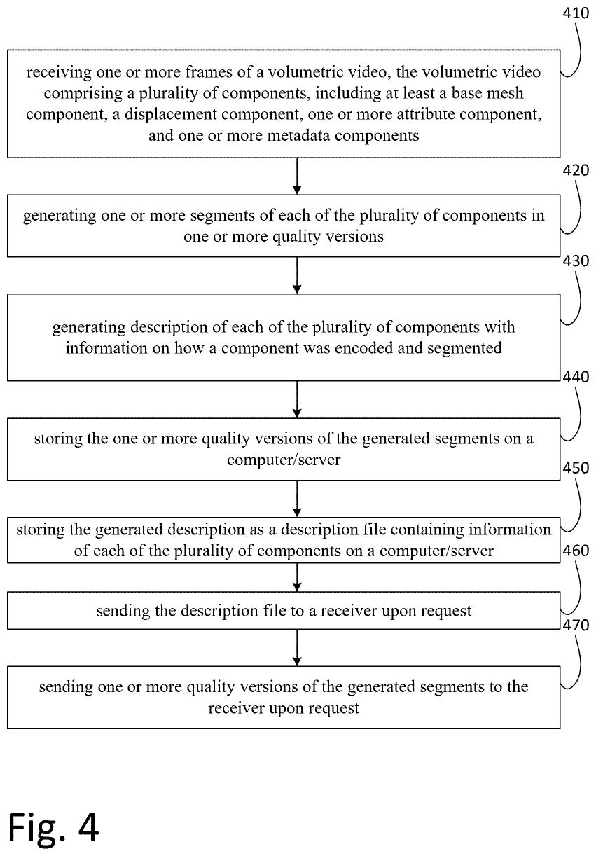

FIG. 4 is a flowchart illustrating a method for encoding according to an embodiment. The method shown in FIG. 4 comprises receiving 410 one or more frames of a volumetric video, the volumetric video comprising a plurality of components, including at least a base mesh component, a displacement component, one or more attribute component, and one or more metadata components; generating 420 one or more segments of each of the plurality of components in one or more quality versions; generating 430 description of each of the plurality of components with information on how a component was encoded and segmented; storing 440 the one or more quality versions of the generated segments on a computer/server; storing 450 the generated description as a description file containing information of each of the plurality of components on a computer/server; sending 460 the description file upon request to a receiver, and sending 470 one or more quality versions of the generated segments upon request of the receiver. The steps of the method as shown in FIG. 4 can be implemented with a respective computer module of a computer system.

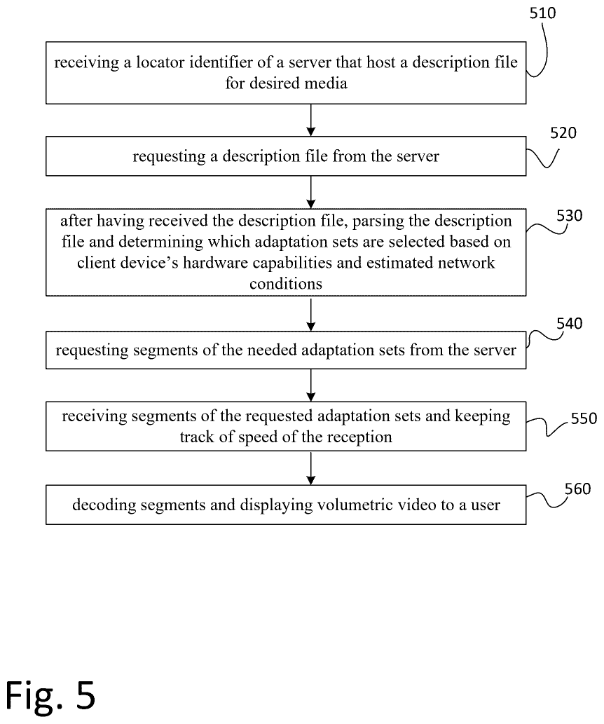

FIG. 5 is a flowchart illustrating a method for decoding according to an embodiment. The method shown in FIG. 5 comprises receiving 510 a locator identifier (e.g., URL) of a server that hosts a description file for desired media; requesting 520 a description file from the server; after having received the description file, parsing 530 the description file and determining which adaptation sets are selected initially based on client device hardware capabilities and estimated network conditions; requesting 540 segments of the needed adaptation sets from the server; receiving 550 segments of the requested adaptation sets while keeping track of speed of the reception; and decoding 560 segments and displaying volumetric video to a user. In case of a packed video with embedded video coded displacement information, the decoder rewrites packing information values in decoded atlas data based on the description file. The steps of the method as shown in FIG. 5 can be implemented with a respective computer module of a computer system.

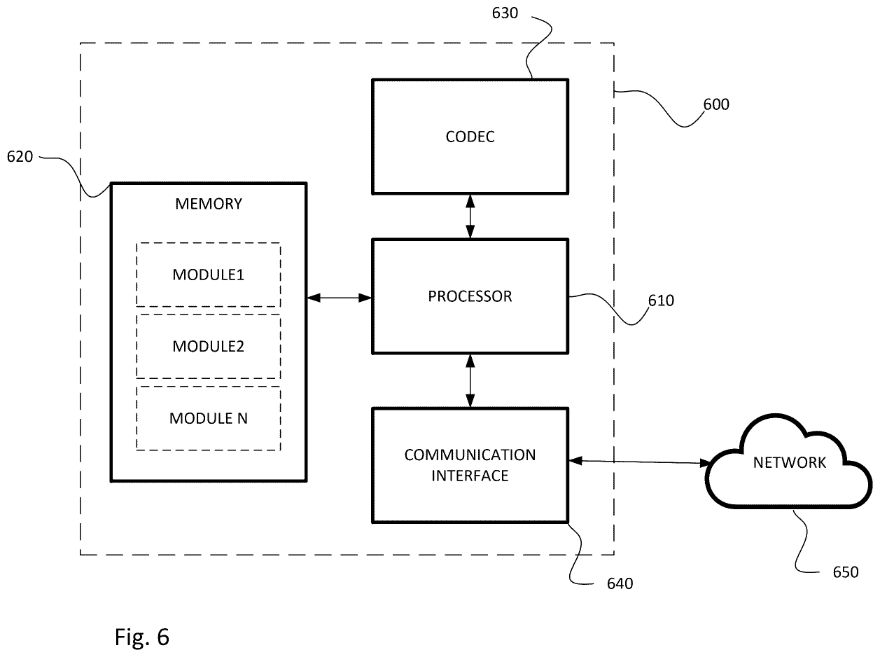

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer-readable storage medium that may be any media or means that can contain or store the instructions for use by or in connection with an instruction execution system, apparatus, or device, such as a computer.

FIG. 6 illustrates an example of an electronic apparatus 600, being an example of video coding system where the present embodiments can be implemented. In some embodiments, the apparatus may be a mobile terminal or a user equipment of a wireless communication system or a camera device. The apparatus 600 may also be comprised at a local or a remote server or a graphic processing unit of a computer. The apparatus may also be comprised as part of a head-mounted display device.

The apparatus 600 comprises one or more processors 610 and one or more memories 620 and one or more transceivers interconnected through one or more buses. The one or more memories 620 store computer instructions, for example in respective modules (Module1, Module2, ModuleN). The one or more memories may store data in the form of image, video and/or audio data, and/or may also store instructions to be executed by the processors or the processor circuitry. The one or more processors may comprise a central processing unit (CPU) and/or a graphical processing unit (GPU). The one or more buses may be address, data or control buses, and may include interconnection mechanism, such as a series of lines on a motherboard or integrated circuit, fiber optics or other optical communication equipment. The apparatus also comprises a codec 630 that is configured to implement various embodiments relating to present solution. According to some embodiments, the apparatus may comprise an encoder or a decoder. The apparatus 600 also comprises a communication interface 640 which is suitable for generating wireless communication signals for example for communication with a cellular communications network, a wireless communications system, or a wireless local area network, and thus enabling data transfer over data transfer network 650.

The apparatus 600 may comprise a display in the form of a liquid crystal display. In other embodiments of the invention the display may be any suitable display technology suitable to display an image or video. The apparatus 600 may further comprise a keypad. In other embodiments of the invention any suitable data or user interface mechanism may be employed. For example, the user interface may be implemented as a virtual keyboard or data entry system as part of a touch-sensitive display. The apparatus 600 may comprise a microphone or any suitable audio input which may be a digital or analogue signal input. The apparatus 600 may further comprise an audio output device which in embodiments of the invention may be any one of: an earpiece, speaker, or an analogue audio or digital audio output connection. The apparatus 600 may also comprise a battery (or in other embodiments of the invention the device may be powered by any suitable mobile energy device such as solar cell, fuel cell or clockwork generator). The apparatus may further comprise a camera capable of recording or capturing images and/or video. The camera may be a multi-lens camera system having at least two camera sensors. The camera is capable of recording or detecting individual frames which are then passed to the codec 630 or to processor 610. The apparatus may receive the video and/or image data for processing from another device prior to transmission and/or storage.

The apparatus 600 may further comprise e.g., the other functional units disclosed e.g., in FIG. 1 for implementing any of the present embodiments.

The apparatus may operate in a system, comprising multiple communication devices, which can communicate through one or more networks. The system may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

For example, the system can be a mobile telephone network enabling a connection to the internet. The connection can form, but is not limited to, long range wireless connections, short range wireless connections, and various wired connections including, but not limited to, telephone lines, cable lines, power lines, and similar communication pathways.

The example communication devices operating in the system may include, but are not limited to, an electronic device or apparatus, a combination of a personal digital assistant (PDA) and a mobile telephone, a PDA, an integrated messaging device (IMD), a desktop computer, a notebook computer, each of which can be a representative of the apparatus according to present embodiments. The apparatus according to present embodiments may be stationary or mobile when carried by an individual who is moving. The apparatus may also be located in a mode of transport including, but not limited to, a car, a truck, a taxi, a bus, a train, a boat, an airplane, a bicycle, a motorcycle, or any similar suitable mode of transport.

The apparatus may also be a set-top box; i.e. a digital TV receiver, which may/may not have a display or wireless capabilities, a tablet or (laptop) a personal computer (PC), which have hardware or software or combination of the encoder/decoder implementations, in various operating systems, or a chipset, processor, DSP and/or embedded system offering hardware/software based coding.

The apparatus according to present embodiments may send and receive calls and messages and communicate with service providers through a wireless connection to a base station. The base station may be connected to a network server that allows communication between the mobile telephone network and the internet.

The apparatus may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

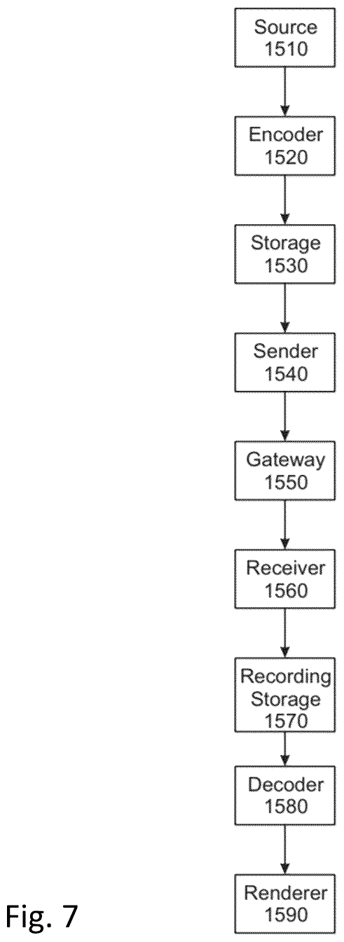

FIG. 7 is a graphical representation of an example multimedia communication system within which various embodiments may be implemented. A data source 1510 provides a source signal in an analog, uncompressed digital, or compressed digital format, or any combination of these formats. An encoder 1520 may include or be connected with a pre-processing, such as data format conversion and/or filtering of the source signal. The encoder 1520 encodes the source signal into a coded media bitstream. It should be noted that a bitstream to be encoded may be received directly or indirectly from a remote device located within virtually any type of network. Additionally, the bitstream may be received from local hardware or software. The encoder 1520 may be capable of encoding more than one media type, such as audio and video, or more than one encoder 1520 may be required to code different media types of the source signal. The encoder 1520 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1520 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1530. The storage 1530 may comprise any type of mass memory to store the coded media bitstream. The format of the coded media bitstream in the storage 1530 may be an elementary self-contained bitstream format, or one or more coded media bitstreams may be encapsulated into a container file, or the coded media bitstream may be encapsulated into a Segment format suitable for DASH (or a similar streaming system) and stored as a sequence of Segments. If one or more media bitstreams are encapsulated in a container file, a file generator (not shown in the figure) may be used to store the one more media bitstreams in the file and create file format metadata, which may also be stored in the file. The encoder 1520 or the storage 1530 may comprise the file generator, or the file generator is operationally attached to either the encoder 1520 or the storage 1530. Some systems operate “live”, i.e. omit storage and transfer coded media bitstream from the encoder 1520 directly to the sender 1540. The coded media bitstream may then be transferred to the sender 1540, also referred to as the server, on a need basis. The format used in the transmission may be an elementary self-contained bitstream format, a packet stream format, a Segment format suitable for DASH (or a similar streaming system), or one or more coded media bitstreams may be encapsulated into a container file. The encoder 1520, the storage 1530, and the server 1540 may reside in the same physical device or they may be included in separate devices. The encoder 1520 and server 1540 may operate with live real-time content, in which case the coded media bitstream is typically not stored permanently, but rather buffered for small periods of time in the content encoder 1520 and/or in the server 1540 to smooth out variations in processing delay, transfer delay, and coded media bitrate.

The server 1540 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). When the communication protocol stack is packet-oriented, the server 1540 encapsulates the coded media bitstream into packets. For example, when RTP is used, the server 1540 encapsulates the coded media bitstream into RTP packets according to an RTP payload format. Typically, each media type has a dedicated RTP payload format. It should be again noted that a system may contain more than one server 1540, but for the sake of simplicity, the following description only considers one server 1540.

If the media content is encapsulated in a container file for the storage 1530 or for inputting the data to the sender 1540, the sender 1540 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISOBMFF, for encapsulation of the at least one of the contained media bitstream on the communication protocol.

The server 1540 may or may not be connected to a gateway 1550 through a communication network, which may e.g. be a combination of a CDN, the Internet and/or one or more access networks. The gateway may also or alternatively be referred to as a middle-box. For DASH, the gateway may be an edge server (of a CDN) or a web proxy. It is noted that the system may generally comprise any number gateways or alike, but for the sake of simplicity, the following description only considers one gateway 1550. The gateway 1550 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. The gateway 1550 may be a server entity in various embodiments.

The system includes one or more receivers 1560, typically capable of receiving, de-modulating, and de-capsulating the transmitted signal into a coded media bitstream. The coded media bitstream may be transferred to a recording storage 1570. The recording storage 1570 may comprise any type of mass memory to store the coded media bitstream. The recording storage 1570 may alternatively or additively comprise computation memory, such as random-access memory. The format of the coded media bitstream in the recording storage 2170 may be an elementary self-contained bitstream format, or one or more coded media bitstreams may be encapsulated into a container file. If there are multiple coded media bitstreams, such as an audio stream and a video stream, associated with each other, a container file is typically used and the receiver 1560 comprises or is attached to a container file generator producing a container file from input streams. Some systems operate “live,” i.e. omit the recording storage 1570 and transfer coded media bitstream from the receiver 1560 directly to the decoder 1580. In some systems, only the most recent part of the recorded stream, e.g., the most recent 10-minute excerption of the recorded stream, is maintained in the recording storage 1570, while any earlier recorded data is discarded from the recording storage 1570.

The coded media bitstream may be transferred from the recording storage 1570 to the decoder 1580. If there are many coded media bitstreams, such as an audio stream and a video stream, associated with each other and encapsulated into a container file or a single media bitstream is encapsulated in a container file e.g., for easier access, a file parser (not shown in the figure) is used to decapsulate each coded media bitstream from the container file. The recording storage 1570 or a decoder 1580 may comprise the file parser, or the file parser is attached to either recording storage 1570 or the decoder 1580. It should also be noted that the system may include many decoders, but here only one decoder 1580 is discussed to simplify the description without a lack of generality.

The coded media bitstream may be processed further by a decoder 1580, whose output is one or more uncompressed media streams. Finally, a renderer 1590 may reproduce the uncompressed media streams with a loudspeaker or a display, for example. The receiver 1560, recording storage 1570, decoder 1580, and renderer 1590 may reside in the same physical device or they may be included in separate devices.

A sender 1540 and/or a gateway 1550 may be configured to perform switching between different representations e.g. for switching between different viewports of 360-degree video content, view switching, bitrate adaptation and/or fast start-up, and/or a sender 1540 and/or a gateway 1550 may be configured to select the transmitted representation(s). Switching between different representations may take place for multiple reasons, such as to respond to requests of the receiver 1560 or prevailing conditions, such as throughput, of the network over which the bitstream is conveyed. In other words, the receiver 1560 may initiate switching between representations. A request from the receiver can be, e.g., a request for a Segment or a Subsegment from a different representation than earlier, a request for a change of transmitted scalability layers and/or sub-layers, or a change of a rendering device having different capabilities compared to the previous one. A request for a Segment may be an HTTP GET request. A request for a Subsegment may be an HTTP GET request with a byte range. Additionally, or alternatively, bitrate adjustment or bitrate adaptation may be used for example for providing so-called fast start-up in streaming services, where the bitrate of the transmitted stream is lower than the channel bitrate after starting or random-accessing the streaming in order to start playback immediately and to achieve a buffer occupancy level that tolerates occasional packet delays and/or retransmissions. Bitrate adaptation may include multiple representation or layer up-switching and representation or layer down-switching operations taking place in various orders.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

A decoder 1580 may be configured to perform switching between different representations e.g., for switching between different viewports of 360-degree video content, view switching, bitrate adaptation and/or fast start-up, and/or a decoder 1580 may be configured to select the transmitted representation(s). Switching between different representations may take place for multiple reasons, such as to achieve faster decoding operation or to adapt the transmitted bitstream, e.g. in terms of bitrate, to prevailing conditions, such as throughput, of the network over which the bitstream is conveyed. Faster decoding operation might be needed for example if the device including the decoder 1580 is multi-tasking and uses computing resources for other purposes than decoding the video bitstream. In another example, faster decoding operation might be needed when content is played back at a faster pace than the normal playback speed, e.g. twice or three times faster than conventional real-time playback rate.

In the above, some embodiments have been described with reference to and/or using terminology of HEVC and/or VVC. It needs to be understood that embodiments may be similarly realized with any video encoder and/or video decoder.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising: at least one processor; and at least one memory storing instructions that, when executed by the at least one processor, cause the apparatus to perform at least the following: receive one or more frames of a volumetric video, the volumetric video comprising a plurality of components, including at least a base mesh component, a displacement component, one or more attribute component, and one or more metadata components; generate one or more segments of each of the plurality of components in one or more quality versions; generate description of each of the plurality of components with information on how a component was encoded and segmented; store the one or more quality versions of the generated segments on a computer/server; store the generated description as a description file containing information of each of the plurality of components on a computer/server; send the description file upon request to a receiver, and send one or more quality versions of the generated segments upon request of the receiver.

2. The apparatus according to claim 1, being further caused to pack the plurality of components in a same packed video component and to generate a description of the packed component.

3. The apparatus according to claim 1, wherein the description contains one or more of the following: a resolution, a bitrate, a codec, a segment length.

4. The apparatus according to claim 2, wherein the description comprises information on how geometry component is packed in the packed component.

5. The apparatus according to claim 1, wherein the metadata component is an atlas.

6. The apparatus according to claim 1, wherein the description file is a media presentation description.

7. The apparatus according to claim 1, further being caused to generate the description file containing a descriptor identifying a mesh component.

8. The apparatus according to claim 7, wherein the mesh component defines one or more of the following: a codec used for encoding; reference to an atlas needed for decoding the base-mesh; type of the base-mesh; number of sub-meshes; identifiers of sub-meshes.

9. The apparatus according to claim 1, further being caused to generate the description file containing a descriptor identifying an arithmetic coded displacement data component.

10. The apparatus according to claim 9, wherein the arithmetic coded displacement data component defines one or more of the following: a coding format of arithmetic coded displacement data; identifier for linking the arithmetic coded displacement data component to other components; identifiers for sub-meshes; type of the arithmetic coded displacement data component.

11. The apparatus according to claim 1, further being caused to generate the description file containing a descriptor identifying a video component supporting packing adaptation.

12. The apparatus according to claim 11, wherein the video component defines one or more of the following: axis of geometry component along; an order of the geometry component.

13. An apparatus comprising: at least one processor; and at least one memory storing instructions that, when executed by the at least one processor, cause the apparatus to perform at least the following: receive a locator identifier of a server that hosts a description file for desired media; request a description file from the server; after having received the description file; parse the description file and determining which adaptation sets are selected initially based on client device hardware capabilities and estimated network conditions; request segments of the needed adaptation sets from the server; receive segments of the requested adaptation sets while keeping track of speed of the reception; decode segments; and display volumetric video to a user.

14. The apparatus according to claim 13, further being caused to determine a descriptor identifying a mesh component from the description file.

15. The apparatus according to claim 14, wherein the mesh component defines one or more of the following: a codec used for encoding; reference to an atlas needed for decoding the base-mesh; type of the base-mesh; number of sub-meshes; identifiers of sub-meshes.

16. The apparatus according to claim 13, further being caused to determine a descriptor identifying an arithmetic coded displacement data component from the description file.

17. The apparatus according to claim 16, wherein the arithmetic coded displacement data component defines one or more of the following: a coding format of arithmetic coded displacement data; identifier for linking the arithmetic coded displacement data component to other components; identifiers for sub-meshes; type of the arithmetic coded displacement data component.

18. The apparatus according to claim 13, further being caused to determine a descriptor identifying a video component supporting packing adaptation from the description file.

19. The apparatus according to claim 18, wherein the video component defines one or more of the following: axis of geometry component along; an order of the geometry component.

20. A method comprising: receiving a locator identifier of a server that hosts a description file for desired media; requesting a description file from the server; after having received the description file, parsing the description file and determining which adaptation sets are selected initially based on client device hardware capabilities and estimated network conditions; requesting segments of the needed adaptation sets from the server; receiving segments of the requested adaptation sets while keeping track of speed of the reception; and decoding segments and displaying volumetric video to a user.
